(19) United States
(12) Patent Application Publication
(10) Pub. No.: US 2010/0108612 A1
(43) Pub. Date: May 6, 2010

(54) APPARATUS AND METHOD FOR REMOVING SMALL MOLECULE ORGANIC PHARMACEUTICALS FROM AQUEOUS SOLUTIONS

(75) Inventors: Paul L. Edmiston, Wooster, OH (US); Laura Underwood, Wooster, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Absorbent Materials Company LLC

(21) Appl. No.: 12/560,083

(22) Filed: Sep. 15, 2009

Related U.S. Application Data
(63) Continuation-in-part of application No. 11/537,944, filed on Oct. 2, 2006.
(60) Provisional application No. 60/722,619, filed on Sep. 30, 2005.

(51) Int. Cl. B01D 15/04; B01J 20/22

(52) U.S. Cl. 210/691; 210/490; 210/198.1

(57) ABSTRACT

A swellable sol-gel composition includes a plurality of interconnected organosilica nanoparticles. The swellable sol-gel composition is capable of removing a small molecule organic pharmaceutical having a log K_{ow} of at least about −0.32 from an aqueous solution.

### RELATED APPLICATIONS

This application is a continuation-in-part of U.S. patent application Ser. No. 11/537,944, filed Oct. 2, 2006, which claims priority from U.S. Provisional Patent Application Ser. No. 60/722,619, filed on Sep. 30, 2005 (now Expired). The subject matter of the aforementioned applications is hereby incorporated by reference in their entireties.

### TECHNICAL FIELD

The present invention generally relates to swellable sol-gel compositions and methods of use, and more particularly to methods for using swellable sol-gel compositions to remove small molecule organic pharmaceuticals from aqueous solutions.

### BACKGROUND OF THE INVENTION

The U.S. Geological Survey has reported that small molecule organic pharmaceuticals (SMOPs) (e.g., steroids, prescription and non-prescription drugs, antibiotics, hormones, and fragrances) have been detected in water samples collected from streams considered susceptible to contamination from various wastewater sources, such as those downstream from intense urbanization or livestock. Potential risk to aquatic organisms due to SMOP exposure in the environment has been identified as a primary concern given that aquatic organisms may be continually exposed to SMOPs, including multi-generational exposures. There is also concern for subtle effects on ecological receptors when exposed to low concentrations. For humans, consumption of potable water containing trace concentrations of various SMOPs has been identified as one of the primary potential routes of exposure.

Presently, granular activated carbon (GAC) is used for SMOP removal. GAC has been commercially used as an adsorbent for SMOPs in water (e.g., surface water, ground water, and industrial processes). GAC, however, has a limited SMOP absorption capacity in terms of both the total quantity and type of SMOPs removed from aqueous media, and cannot be regenerated after use.

### SUMMARY OF THE INVENTION

The present invention generally relates to swellable sol-gel compositions and methods of use, and more particularly to a method for using swellable sol-gel compositions to remove small molecule organic pharmaceuticals from aqueous solutions.

One aspect of the present invention relates to an apparatus for removing a small molecule organic pharmaceutical (SMOP) from an aqueous solution. The apparatus can include a support structure and a swellable sol-gel composition disposed on or within the support structure. The swellable sol-gel composition can comprise a plurality of interconnected organosilica nanoparticles. The swellable sol-gel composition may be capable of removing from the aqueous solution a SMOP having a log K_{ow} of at least about −0.32.

Another aspect of the present invention relates to a method for removing a SMOP from an aqueous solution. The method can comprise contacting the aqueous solution containing the SMOP with a swellable sol-gel composition. The swellable sol-gel composition can be comprised of a plurality of interconnected organosilica nanoparticles. The swellable sol-gel composition may be capable of removing from the aqueous solution a SMOP having a log K_{ow} of at least about −0.32.

Another aspect of the present invention relates to a system for removing a SMOP from an aqueous solution. The system can include a swellable sol-gel composition and a means for placing the swellable sol-gel composition in contact with the aqueous solution. The swellable sol-gel composition can be comprised of a plurality of interconnected organosilica nanoparticles. The swellable sol-gel composition may be capable of removing from the aqueous solution a log K_{ow} of at least about −0.32.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic illustration showing an apparatus comprising a support structure and a swellable sol-gel composition for removing a small molecule organic pharmaceutical (SMOP) from an aqueous solution according to one aspect of the present invention;

FIG. 2 is a schematic illustration showing swellable organosilica nanoparticles comprising the swellable sol-gel composition that include a hydrophilic inner layer and an aromatic rich outer layer;

FIG. 3 is a schematic illustration showing a proposed model for absorption of dissolved organics by the swellable sol-gel composition based on electron microscopy;

FIG. 4 is a flow diagram illustrating a method for removing a SMOP from an aqueous solution according to another aspect of the present invention; and

FIG. 5 is a plot of partition coefficient, log k, for binding of various contaminants in water by the swellable sol-gel composition versus the log octanol-water partition coefficient, log K_{ow}.

### DETAILED DESCRIPTION

Unless otherwise defined, all technical terms used herein have the same meaning as commonly understood by one of ordinary skill in the art to which the present invention pertains.

In the context of the present invention, the terms “small molecule organic pharmaceutical” or “SMOP” can refer to molecules and/or organic pharmaceuticals that have a molar mass of less than about 1000 grams/mole and are used in the medical treatment of humans or animals. SMOPs can be capable of being taken up by the swellable sol-gel composition of the present invention, whether by adsorption, absorption, or a combination thereof. In one example of the present invention, a SMOP can have a known log octanol-water coefficient (log K_{ow}), which is the ratio of the concentration of a chemical (e.g., a SMOP) in octanol and water at equilibrium and at a specified temperature (e.g., about 25° C.).

As used herein, the term “swellable” can refer to the ability of a swellable sol-gel composition to swell greater than about 2 times its dried volume when placed in contact with a SMOP. For example, the swellable sol-gel composition can swell greater than about 3 times, 4 times, 5 times, 6 times, 7 times, or greater its dried volume when placed in contact with an aqueous solution containing a SMOP.

The present invention generally relates to swellable sol-gel compositions and methods of use, and more particularly to methods for using swellable sol-gel compositions to remove SMOPs from aqueous solutions. The swellable sol-gel composition of the present invention is hydrophobic and does not swell in the presence of water or water vapor. Swelling and absorption of SMOPs can also be driven by the release of stored tensile force rather than by chemical reaction. Swelling can be reversible if the absorbed SMOPs are removed by thermal or chemical treatment. The swellable sol-gel composition is also capable of taking up SMOPs having a particular log K_{ow} value. Generally, the log K_{ow} of a given molecule is inversely related to the molecule's polarity. The swellable sol-gel of the present invention is capable of taking up less polar or non-polar SMOPs. For example, the swellable sol-gel composition can be capable of taking up a SMOP having a log K_{ow} value that is at least about −0.32, which is the point at which the extraction efficiency of the SMOP by the swellable sol-gel is less than about 50%. Thus, the extraction efficiency of the swellable sol-gel composition for more polar molecules (e.g., proteins) may be less than about 50%. Examples of SMOPs with a log K_{ow} of at least about −0.32 can include ketoprofen, naproxen, carbamazepine, clofibric acid, gemfibrozil, fluoxtine, ibuprofen, hexamine, diphenhydramine, estradiol and imipramine, as well as those disclosed by J. Sangster, Octanol-Water Partition Coefficients: Fundamentals and Physical Chemistry (John Wiley & Sons, 1997), which is hereby incorporated by reference in its entirety. Compared to conventional sorbents (e.g., activated carbon, molecular sieves, etc.), the swellable sol-gel composition of the present invention has a higher capacity to absorb SMOPs and can be easily regenerated following absorption of SMOPs.

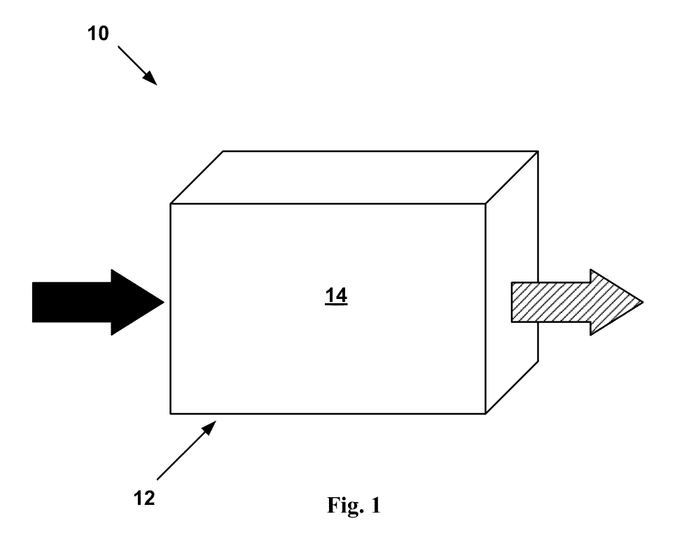

FIG. 1 schematically illustrates an apparatus 10 (FIG. 1) for removing a SMOP having a log K_{ow} of at least about −0.32 from an aqueous solution. The apparatus 10 can include a support structure 12 and a swellable sol-gel composition 14. The swellable sol-gel composition 14 can be disposed on or within the support structure 12. The support structure 12 can comprise any type of solid or semi-solid object capable of directly or indirectly supporting the swellable sol-gel composition 14. For example, the support structure 12 can be any type of container, vessel, or material having at least one surface capable of supporting the swellable sol-gel composition 14. By “directly” it is meant that the swellable sol-gel composition 14 can be in intimate physical contact with at least one surface of the support structure 12. For example, the swellable sol-gel composition 14 can be attached, bonded, coupled to, or mated with all or only a portion of the at least one surface. By “indirectly” it is meant that the swellable sol-gel composition 14 can be housed by or within the support structure 12 without being in direct contact with the support structure. For example, the swellable sol-gel composition 14 can be afloat in a fluid (e.g., water) that is contained by the support structure 12.

In one example of the present invention, the support structure 12 can be a fixed bed reactor (e.g., a packed or fluidized bed reactor). The fixed bed reactor can contain a swellable sol-gel composition 14 so that the swellable sol-gel composition remains stationary or substantially stationary when an aqueous solution containing a SMOP is flowed therethrough. The fixed bed reactor can include at least one inlet through which the aqueous solution is applied and at least one outlet through which an aqueous solution that is substantially free of SMOPs is discharged. The fixed bed reactor can additionally include an inert, non-swelling filler or media (e.g., ground glass) to provide void spaces for swelling of the swellable sol-gel composition 14. The fixed bed reactor can have any shape (e.g., cylindrical), dimensions, and orientation (e.g., vertical or horizontal). The fixed bed reactor may be stand-alone or placed directly in-line with an aqueous solution containing SMOPs.

In another example of the present invention, the support structure 12 can be a filter. The filter can include at least one porous membrane that is entirely or partially formed with, coupled to, bonded with, or otherwise in intimate contact with the swellable sol-gel composition 14. For example, the filter can have a sandwich-like configuration and comprise a swellable sol-gel composition 14 disposed on or embedded between first and second porous membranes. The porous membrane can include a porous material (e.g., a metal, metal alloy, or polymer) having pores of sufficient size to permit passage of an aqueous solution containing SMOPs therethrough. For example, the porous membrane can be comprised of a nano- or micro-sized polymer or polymer-blended material, such as a nano-sized nylon-polyester blend.

In yet another example of the present invention, the support structure 12 can be a vessel capable of holding an aqueous solution containing a SMOP. The vessel can comprise, for example, a stirred tank or vat. The swellable sol-gel composition 14 can be disposed on or embedded within at least one surface of the vessel. Alternatively, the swellable sol-gel composition 14 can be suspended (e.g., floating) in the aqueous solution contained within the vessel.

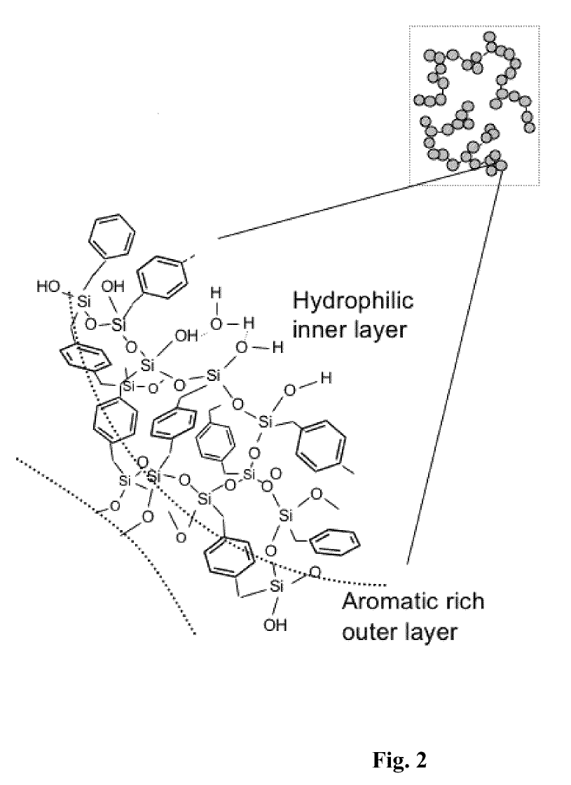

The swellable sol-gel composition 14 can be disposed on or within the support structure 12 and can be similar or identical to the swellable materials described in parent U.S. patent application Ser. No. 11/537,944 (hereinafter, “the '944 Application”). For example, the swellable sol-gel composition 14 can include a plurality of flexibly tethered and interconnected organosilica particles having diameters on the nanometer scale. The plurality of interconnected organosilica nanoparticles can form a disorganized microporous array or matrix defined by a plurality of cross-linked aromatic siloxanes. As shown in FIG. 2, the organosilica nanoparticles can have a multilayer configuration comprising a hydrophilic inner layer and a hydrophobic, aromatic-rich outer layer.

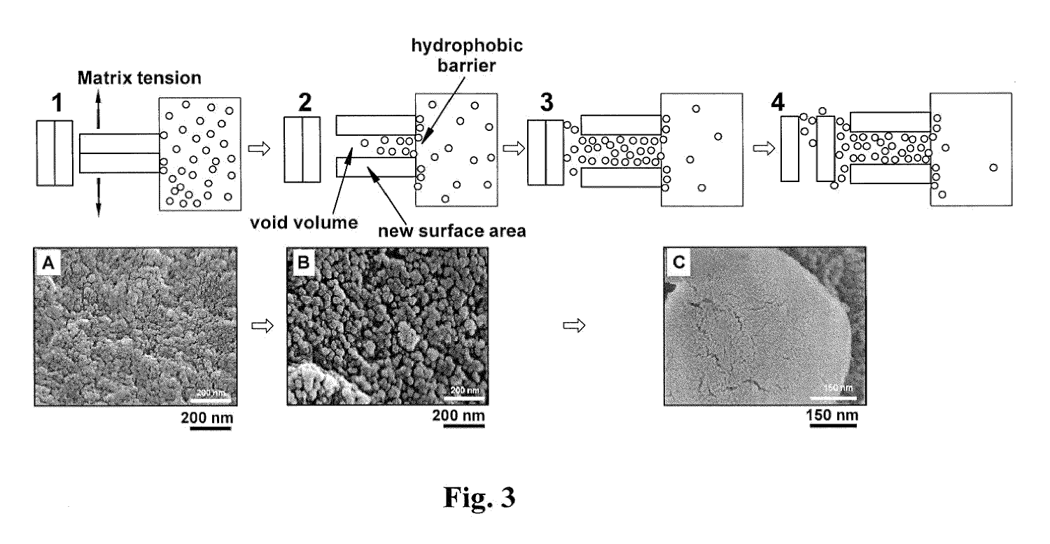

The swellable sol-gel composition 14 has the ability to swell to at least twice its dried volume when placed in contact with a SMOP. Without being bound by theory, it is believed that swelling may be derived from the morphology of interconnected organosilica particles that are crosslinked during the gel state to yield a nanoporous material or polymeric matrix. Upon drying the gel and following a derivatization step, tensile forces may be generated by capillary-induced collapse of the polymeric matrix. Stored energy can be released as the matrix relaxes to an expanded state when SMOPs disrupt the inter-particle interactions holding the dried material in the collapsed state. New surface area and void volume may then be created, which serves to further capture additional SMOPs that can diffuse into the expanded pore structure. As shown in FIG. 3, for example, initial adsorption to the surface of the composition (FIG. 3-1) occurs in the dry, non-swollen state (FIG. 3A). Sufficient adsorption then occurs to trigger matrix expansion (FIG. 3-2), which leads to absorption across the composition-water boundary (FIG. 3B). Pore filling leads to further percolation into the composition (FIG. 3-3), followed by continued composition expansion to increase available void volume (FIG. 3C).

As described in the '944 Application, the organosilica nanoparticles can be formed from bridged polysiloxanes that include an aromatic bridging group, which is flexibly linked between silicon atoms of the polysiloxanes. Briefly, the organosilica nanoparticles can be formed from bridged silane precursors having the structure:

(alkoxy)₃Si—(CH₂)ₙ—Ar—(CH₂)ₘ—Si(alkoxy)₃

wherein n and m can individually be an integer from 1 to 8, Ar can be a single-, fused-, or poly-aromatic ring, and each alkoxy can independently be a C1 to C5 alkoxy. Examples of bridged silane precursors can include 1,4-bis(trimethoxysilylmethyl)benzene, bis(trimethoxysilylethyl)benzene (BTEB), and mixtures thereof.

Conditions for sol-gel formation can include polymerization of bridged silane precursor molecules using acid or base catalysts in appropriate solvents. Examples of base catalysts can include tetrabutyl ammonium fluoride (TBAF), sodium fluoride (or other fluoride salts), 1,5-diazabicyclo[4.3.0]non-5-ene (DBN), and alkylamines (e.g., propyl amine). Examples of solvents for use with base catalysts can include tetrahydrofuran (THF), acetone, and dichloromethane/THF mixtures. Examples of acid catalysts can include any strong acid, such as hydrochloric acid, phosphoric acid, and sulfuric acid. Solvents for use with acid catalysts can include those identified above for use with base catalysts.

After polymerization, the gelled composition can be aged for a duration of time effective to induce syneresis (e.g., from about 15 minutes to about 7 days). Solvent and catalyst extraction can be carried out (i.e., rinsing) after or during the aging process. After removing solvent and catalyst, the aged composition can be subjected to a derivatization step to end-cap the silanol-terminated polymers present in the gel. Reagents used for the derivatization step can include halosilane reagents containing at least one halogen group and at least one alkyl group. Following derivatization, the derivatized gel can be rinsed and dried, e.g., in an oven for about 2 hours at about 60° C.

Another aspect of the present invention includes a system for removing a SMOP having a log K_{ow} of at least about −0.32 from an aqueous solution. The system can comprise a swellable sol-gel composition 14 and a means for placing the swellable sol-gel composition in contact with the aqueous solution. The swellable sol-gel composition 14 can comprise a plurality of interconnected organosilica nanoparticles. The means for placing the swellable sol-gel composition 14 in contact with the aqueous solution can be a support structure 12. As described above, the support structure 12 can comprise any type of solid or semi-solid object capable of directly or indirectly supporting the swellable sol-gel composition 14. Examples of support structures 12 are described above.

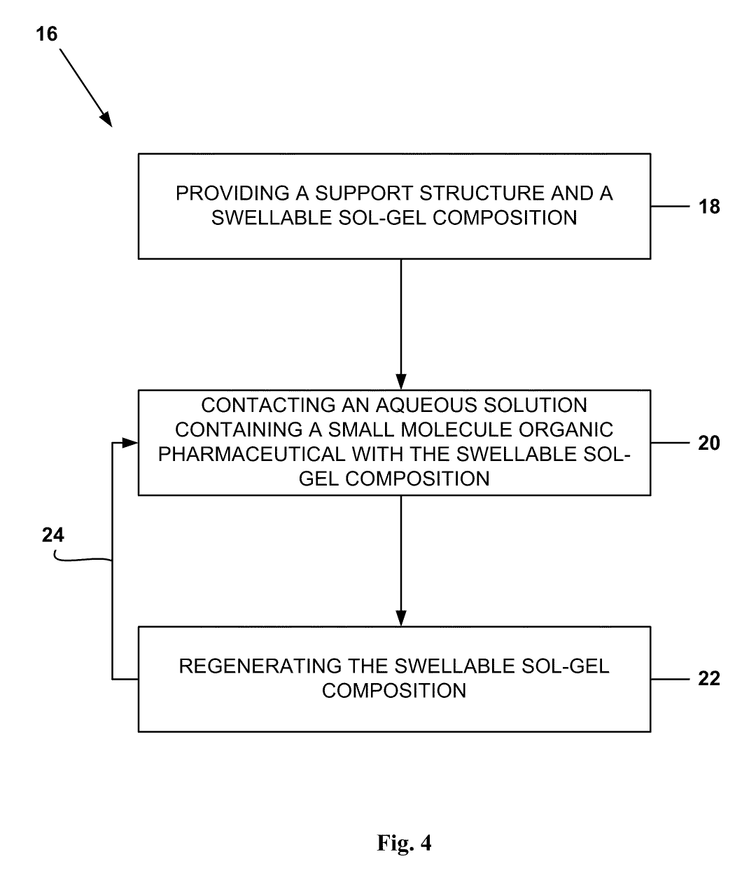

FIG. 4 illustrates another aspect of the present invention comprising a method 16 for removing a SMOP having a log K_{ow} of at least about −0.32 from an aqueous solution. As described in more detail below, the method 16 can find use in a variety of SMOP extraction applications, such as in the manufacture of drugs. For example, the method 16 may find use in recovering SMOPs from chemical reactions carried out in aqueous solution during drug manufacture. Additionally, the method 16 may find use in preventing or mitigating discharge of SMOPs into the environment from a waste stream. For example, the method 16 may find use in remediating aqueous streams containing SMOPs produced by SMOP production or other industrial processes or facilities (e.g., livestock facilities). The terms “remediating” and “remediation” can refer to the substantially complete removal of aqueous pollutants (i.e., SMOPs) to achieve the standard(s) set by the responsible regulatory agency for the particular contaminated aqueous media (e.g., National Primary Drinking Water Regulations for subsurface ground water).

As shown in FIG. 4, the method 16 can include providing a support structure 12 and a swellable sol-gel composition 14 at Step 18. As described above, the support structure 12 can comprise any type of solid or semi-solid object capable of directly or indirectly supporting the swellable sol-gel composition 14. The support structure 12 chosen at Step 18 will depend upon the particular type of SMOP removal activity. As described in more detail below, for example, a support structure 12 comprising a fixed bed reactor may be used for in-line SMOP remediation. The swellable sol-gel composition 14 can comprise a plurality of interconnected organosilica nanoparticles and be disposed on or within the support structure 12.

At Step 20, the swellable sol-gel composition 14 can be contacted with an aqueous solution containing a SMOP under conditions effective to cause the swellable sol-gel composition to take up the SMOP. The aqueous solution can flow through or be placed into the support structure 12 so that intimate contact may be made between the swellable sol-gel composition 14 and the aqueous solution. If desired, the aqueous solution can be agitated to facilitate intimate contact between the swellable sol-gel composition 14 and the aqueous solution. Upon contact with the aqueous solution, stored energy in the sol-gel composition 14 can be released as the matrix relaxes to an expanded state when the SMOPs disrupt the inter-particle interactions holding the dried material in the collapsed state. New surface area and void volume may then be created, which serves to further capture additional SMOPs that can diffuse into the expanded pore structure. Consequently, absorption of the SMOPs can cause the swellable sol-gel composition 14 to swell to at least twice its dried volume.

The aqueous solution can be contacted with the swellable sol-gel composition 14 until substantially all of the SMOPs have been removed from the aqueous solution, or until the swellable sol-gel composition is saturated with the SMOPs. The SMOPs are capable of being removed along with the swollen sol-gel composition, which is in a solid phase. For example, the swollen sol-gel composition can be directly removed or collected (e.g., using tactile means) from the support structure 12 or, alternatively, via centrifugation, filtration or floatation. Removal of the swollen sol-gel composition can leave behind an aqueous component that is substantially free of SMOPs. The remaining aqueous component can then be cleanly collected by pouring, aspiration, evaporation, distillation, or other means known in the art.

In one aspect of the method 16, the swellable sol-gel composition 14 can remove essentially all of the SMOPs in the aqueous solution. If complete removal is desired, the contaminated aqueous solution can be contacted with enough of the swellable sol-gel composition 14 to avoid complete saturation of the composition or, alternatively, repeatedly contacted with fresh sol-gel composition until substantially complete extraction has been accomplished.

Additionally or alternatively at Step 22, the swollen sol-gel composition can be regenerated or recovered via chemical extraction and/or thermal treatment. For example, the swollen sol-gel composition can be heated for a period of time and at a temperature sufficient to separate the SMOPs from the sol-gel matrix (e.g., in an oven for about 2 hours at about 60° C.). Alternatively, the swollen sol-gel composition can be contacted with an organic solvent (e.g., ethanol) at a concentration (e.g., about 1-5×) and for a time sufficient to separate the SMOPs from the sol-gel matrix.

At Step 24, the regenerated swellable sol-gel composition 14 may then be available for additional SMOP extraction. Steps 22 and 24 can then be repeated until substantially all of the SMOPs are extracted from the aqueous solution.

As noted above, the type of apparatus 10 used to remove SMOPs from an aqueous solution will depend upon the particular type of removal application. In one example of the method 16, an apparatus 10 comprising a fixed bed reactor and a swellable sol-gel composition 14 can be provided for high flow remediation of SMOPs. The fixed bed reactor can comprise a fluid inlet, a fluid outlet, and a swellable sol-gel composition 14 encased between two or more layers of a metal or metal alloy (e.g., stainless steel). The fixed bed reactor can be placed directly in-line with an aqueous solution containing the SMOPs. For example, the fixed bed reactor can be placed in-line with a contaminated water source that is constantly fed from a drug manufacturing facility. The contaminated water can be flowed through the inlet of the fixed bed reactor so that the SMOPs are absorbed by the swellable sol-gel composition 14. The water discharged from the outlet of the fixed bed reactor can be substantially free of SMOPs. As the swellable sol-gel composition 14 absorbs the SMOPs, the swollen sol-gel composition can be removed from the fixed bed reactor, regenerated (e.g., using chemical treatment), and then replaced (if needed) to continuously remove additional SMOPs.

In another example of the method 16, an apparatus 10 comprising a filter and a swellable sol-gel composition 14 can be provided for low flow extraction of SMOPs. The filter can be comprised of first and second nano-porous, polymeric membranes (e.g., nylon-polyester blend) having the swellable sol-gel composition 14 disposed therebetween. The filter can be placed directly in-line with a water source contaminated with SMOPs. The contaminated water can be flowed through the filter so that the SMOPs are absorbed by the swellable sol-gel composition 14 and thereby extracted from the water. The water that has been passed through the filter can be substantially free of SMOPs. As the swellable sol-gel composition 14 absorbs the SMOPs and becomes swollen, the filter can be removed from the polluted water stream, the sol-gel composition regenerated (e.g., using chemical treatment), and the filter then placed back into the stream to remove additional SMOPs. It will be appreciated that a new filter may also be used to replace the used filter, and that two or more filters may be used to extract the SMOPs.

In yet another example of the method 16, a support structure 12 comprising a fillable tank or vat can be used to extract SMOPs from a contaminated aqueous solution. Either prior to, simultaneous with, or subsequent to addition of the contaminated aqueous solution to the fillable tank or vat, an amount of the swellable sol-gel composition 14 can be added to the fillable tank or vat. The contaminated aqueous solution can then be mixed thoroughly using mechanical means or through fluid agitation (e.g., a vortex system). Contact of the swellable sol-gel composition 14 with the contaminated aqueous solution allows the SMOPs to be absorbed by the swellable sol-gel composition. As the swellable sol-gel composition 14 absorbs the SMOPs and becomes swollen, the swollen sol-gel composition can be removed from the fillable tank or vat via floatation, filtration, and/or centrifugation. The removed sol-gel composition can then be regenerated (e.g., using chemical treatment) and, if necessary, added to the fillable tank or vat to remove additional SMOPs.

The following examples are for the purpose of illustration only and are not intended to limit the scope of the claims, which are appended hereto.

### Example 1

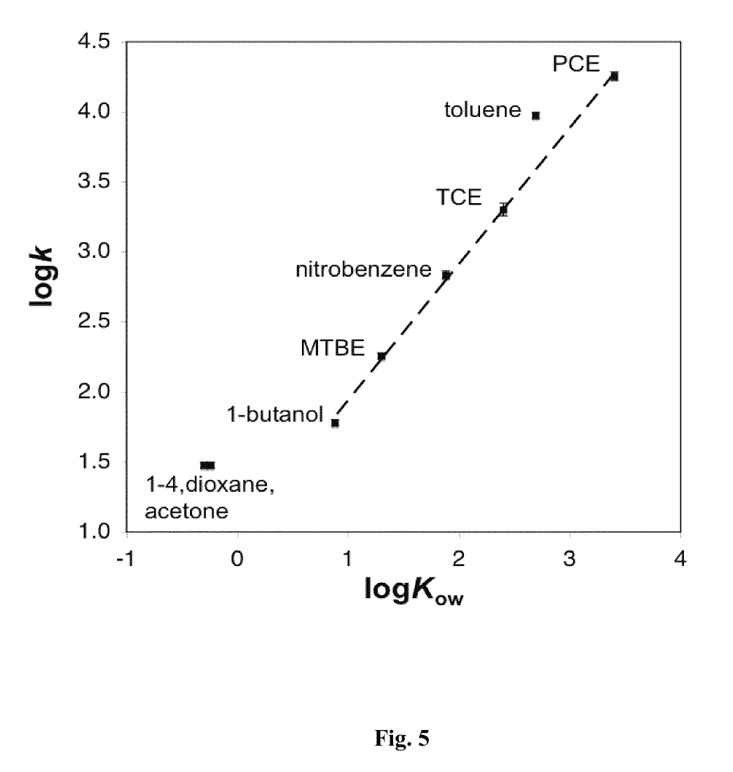

A series of SMOP mimetics was chosen for their ability to be measured in water with a high degree of accuracy and precision by standard analytical methods to determine the effectiveness of extraction using a swellable sol-gel composition. The SMOP mimetics included perchloroethylene (PCE), toluene, trichloroethylene (TCE), nitrobenzene, methyl t-butyl ether (MTBE), 1-butanol, 1,4-dioxane, and acetone. The concentration of SMOP mimetics was 100 ppm, and experiments were done at 25° C. For each of the SMOP mimetics, 0.5% w/v (swellable sol-gel composition/solution) was added to a stirred mixture. The results are shown in FIG. 5, which is a plot of the log of partition coefficient (log k) for binding of the SMOP mimetics in water versus log K_{ow}.

### Example 2

Experiments were conducted by applying a 0.5% w/v swellable sol-gel composition to water contaminated with one of a representative SMOP (Table 1).

TABLE 1
Removal of Representative SMOPs by Sol-gel-Containing Fixed Beds

| | Common | | | | Percent |
|---|---|---|---|---|---|
| SMOP | Name | Usage | pH | logK_{ow} | Extraction |
| Fluoxetine | Prozac | Anti- | 7.0 | 0.29 | 98%* |
| | | depressant | | | |
| Ibuprofen | Advil | Pain relief | 6.0 | 1.8-3.4 | 80% |
| Diphenhydramine | Benadryl | Anti-histamine | 7.0 | 3.2 | 98% |
| Estradiol | Hormone | Contraceptive | 7.0 | 3.6 | >99% |
| Imipramine | Deprenil | Anti- | 7.0 | 4.8 | 99% |
| | | depressant | | | |

*Higher extraction was measured at pH > 7.0.

Three different types of solutions were examined: deionized water; water buffered to pH 7.0 with 0.1M ionic strength; and natural stream water that had been sterilized prior to use. Solutions containing the swellable sol-gel composition were allowed to incubate under constant agitation for 24 hours. The amount of representative SMOPs remaining in solution was assayed by HPLC using UV absorbance for detection according to established protocols (see Venkateswara et al., Chromatographia 66:111-114, 2007; and Nichols et al., Clinical Chemistry 40:1312-1316, 1994). In the case of fluoxetine, the concentration after addition of the swellable sol-gel composition was below the detection limit of the instrument (˜100 ppb).

### Example 3

Experiments were conducted by applying a 4.0% w/v swellable sol-gel composition to deionized water contaminated with ketoprofen, naproxen, carbamazepine, clofibric acid or gemfibrozil, all of which are representative SMOPs. The concentration of the SMOPs was 100 ppm, and experiments were done at 25° C. The amount of the SMOPs remaining in solution was assayed by HPLC using UV absorbance for detection according to the established protocols disclosed in Example 2. After addition of swellable sol-gel derived material, the concentration of the 5 drugs in solution was reduced to below the detection limit of the assay (˜200 ppb).

From the above description of the invention, those skilled in the art will perceive improvements, changes and modifications. Such improvements, changes, and modifications are within the skill of the art and are intended to be covered by the appended claims.

Having described the invention, the following is claimed:

1. An apparatus for removing a small molecule organic pharmaceutical (SMOP) from an aqueous solution, the apparatus comprising:
a support structure; and
a swellable sol-gel composition disposed on or within the support structure, the swellable sol-gel composition comprising a plurality of interconnected organosilica nanoparticles, the swellable sol-gel composition being capable of removing from the aqueous solution a SMOP having a log K_{ow} of at least about −0.32.

2. The apparatus of claim 1, the swellable sol-gel composition being hydrophobic and resistant to absorbing water.

3. The apparatus of claim 1, the organosilica nanoparticles comprising polysiloxanes with an organic bridging group.

4. The apparatus of claim 3, including an aromatic bridging group flexibly linked between silicon atoms of the polysiloxanes.

5. The apparatus of claim 1, the support structure comprising a fixed bed.

6. The apparatus of claim 5, the fixed bed including an inert filler.

7. The apparatus of claim 1, the support structure comprising a filter.

8. The apparatus of claim 1, the sol-gel composition being capable of swelling at least twice its dried volume when placed in contact with the SMOP.

9. The apparatus of claim 1, the SMOP having a molar mass of about 1000 grams/mole or less.

10. A method for removing a SMOP from an aqueous solution, the method comprising the step of:
contacting the aqueous solution containing the SMOP with a swellable sol-gel composition under conditions effective to cause the swellable sol-gel composition to take up the SMOP, the swellable sol-gel composition comprising a plurality of interconnected organosilica particles;
wherein the SMOP has a log K_{ow} of at least about −0.32.

11. The method of claim 10, the swellable sol-gel composition being capable of swelling to at least twice its dried volume when placed in contact with the SMOP.

12. The method of claim 10, the contacting step further comprising the step of agitating the aqueous solution containing the SMOP and the swellable sol-gel composition.

13. The method of claim 10, further comprising the steps of:
collecting the swollen sol-gel composition; and
separating the SMOP from the sol-gel composition.

14. The method of claim 10, the swellable sol-gel composition being disposed on or within a support structure.

15. The method of claim 14, the support structure comprising a fixed bed.

16. The method of claim 15, the fixed bed including an inert filler.

17. The method of claim 14, the support structure comprising a filter.

18. The method of claim 11, the SMOP having a molar mass of about 1000 grams/mole or less.

19. A system for removing a SMOP from an aqueous solution, the system comprising:
a swellable sol-gel composition comprising a plurality of interconnected organosilica particles, the swellable sol-gel composition being capable of removing from the aqueous solution a SMOP having a log K_{ow} of at least about −0.32; and
means for placing the swellable sol-gel composition in contact with the aqueous solution.

20. The system of claim 19, the swellable sol-gel composition being capable of swelling to at least twice its dried volume when placed in contact with the SMOP.

21. The system of claim 19, the swellable sol-gel composition being hydrophobic and resistant to absorbing water.

22. The system of claim 19, the organosilica nanoparticles comprising polysiloxanes with an organic bridging group.

23. The system of claim 22, including an aromatic bridging group flexibly linked between silicon atoms of the polysiloxanes.

24. The system of claim 19, the means for placing the swellable sol-gel composition in contact with the aqueous solution comprising a support structure.

25. The system of claim 24, the support structure comprising a fixed bed.

26. The system of claim 25, the fixed bed including an inert filler.

27. The system of claim 24, the support structure comprising a filter.

28. The system of claim 19, the SMOP having a molar mass of about 1000 grams/mole or less.
